(19) United States
(12) Patent Application Publication
(10) Pub. No.: US 2016/0050270 A1
(43) Pub. Date: Feb. 18, 2016

(54) COMMUNICATION TERMINAL, COMMUNICATION SYSTEM, COMMUNICATION METHOD, AND NON-TRANSITORY COMPUTER READABLE MEDIUM

(71) Applicant: FUJI XEROX CO., LTD., Tokyo (JP)

(72) Inventors: Akira KADODA, Kanagawa (JP); Yusuke MORITA, Kanagawa (JP); Satoshi KAWAMURA, Kanagawa (JP); Tatsuo FUKUSHIMA, Kanagawa (JP)

(73) Assignee: FUJI XEROX CO., LTD., Tokyo (JP)

(21) Appl. No.: 14/695,631

(22) Filed: Apr. 24, 2015

(30) Foreign Application Priority Data
Aug. 15, 2014 (JP) 2014-165463

(51) Int. Cl. H04L 29/08

(52) U.S. Cl. CPC H04L 67/1095; H04L 67/06

(57) ABSTRACT

A communication terminal includes an attribute data acquisition unit that acquires attribute data indicating an attribute of real data if at least a single piece of the real data is added or updated as one of content items on a data memory, a notification controller that controls a notification unit to notify a user of the attribute indicated by the attribute data acquired by the attribute data acquisition unit, and a real data acquisition unit that acquires real data predetermined as an acquisition target by the communication terminal with the notification controller not notifying the user of the attribute indicated by the attribute data if the attribute indicated by the attribute data acquired by the attribute data acquisition unit matches the attribute of the predetermined real data.

### CROSS-REFERENCE TO RELATED APPLICATIONS

This application is based on and claims priority under 35 USC 119 from Japanese Patent Application No. 2014-165463 filed Aug. 15, 2014.

### BACKGROUND

(i) Technical Field

The present invention relates to a communication terminal, a communication system, a communication method, and a non-transitory computer readable medium.

(ii) Related Art

Techniques referred to as file synchronization are available to match the contents of files across multiple apparatuses.

### SUMMARY

According to an aspect of the invention, there is provided a communication terminal. The communication terminal includes an attribute data acquisition unit that acquires attribute data indicating an attribute of real data if at least a single piece of the real data is added or updated as one of content items on a data memory, a notification controller that controls a notification unit to notify a user of the attribute indicated by the attribute data acquired by the attribute data acquisition unit, and a real data acquisition unit that acquires real data predetermined as an acquisition target by the communication terminal with the notification controller not notifying the user of the attribute indicated by the attribute data if the attribute indicated by the attribute data acquired by the attribute data acquisition unit matches the attribute of the predetermined real data.

### BRIEF DESCRIPTION OF THE DRAWINGS

Exemplary embodiments of the present invention will be described in detail based on the following figures, wherein:

FIG. 1 illustrates an example of the configuration of a communication system;

FIG. 2 is a block diagram illustrating the hardware configuration of a client terminal;

FIG. 3 illustrates the data structure of a basic attribute table;

FIG. 4 illustrates the data structure of a detailed attribute table;

FIG. 5 is a functional block diagram of a controller;

FIG. 6 illustrates an example of a screen displayed on a display;

FIG. 7 is a block diagram illustrating the hardware configuration of a server;

FIG. 8 is a sequence chart illustrating an example of a file synchronization process;

FIG. 9 is a flowchart illustrating an example of a determination process;

FIG. 10 is a functional block diagram of the controller;

FIG. 11 illustrates an example of the screen displayed on the display; and

FIG. 12 is a sequence chart of an example of a real file synchronization process.

### DETAILED DESCRIPTION

Exemplary embodiments of the present invention are described with respect to the drawings.

### Exemplary Embodiment

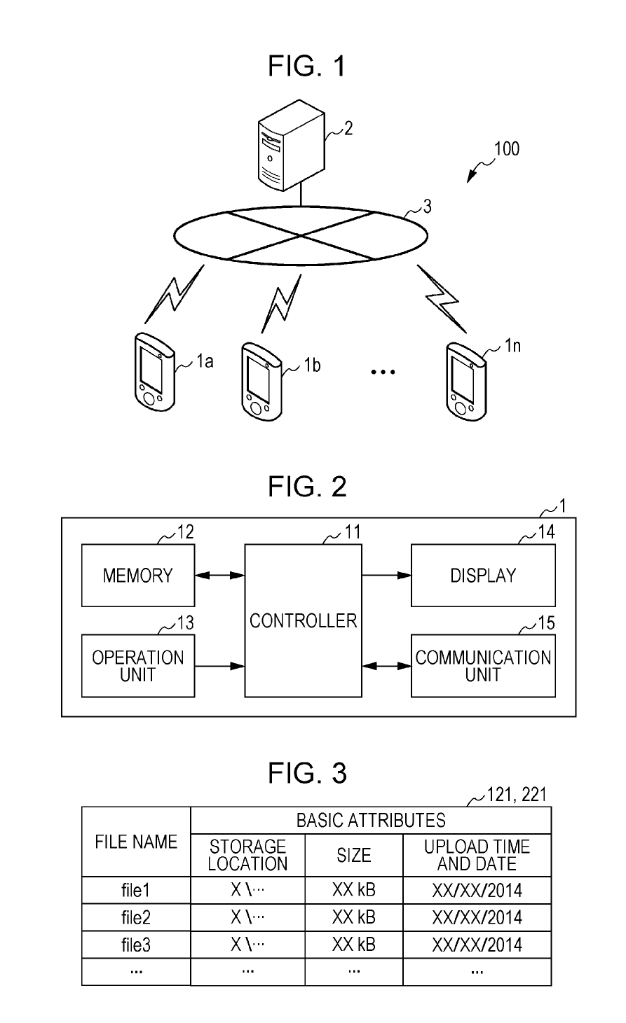

FIG. 1 illustrates the configuration of a communication system 100 of an exemplary embodiment. As illustrated in FIG. 1, the communication system 100 includes multiple client terminals 1a, 1b, . . . , 1n (hereinafter collectively referred to as a “client terminal 1”), and a server 2. Each client terminal 1 is connected to the server 2 via a communication network 3. The communication network 3 includes a mobile communication network, the Internet, and a combination thereof, for example. In the communication system 100, the client terminals 1 perform file synchronization via the server 2.

FIG. 2 is a block diagram illustrating the hardware configuration of the client terminal 1. The client terminal 1 is a personal computer, for example. More specifically, the client terminal 1 may be a mobile terminal, such as a smart phone or a tablet terminal, or a desktop computer. The client terminal 1 may be an image forming apparatus functioning as a photocopying machine, a printer, a scanner, or a facsimile machine. The client terminal 1 may be an example of a “communication terminal” in the exemplary embodiment.

As illustrated in FIG. 2, the client terminal 1 includes a controller 11, a memory 12, an operation unit 13, a display 14, and a communication unit 15.

The controller 11 includes a central processing unit (CPU), a read-only memory (ROM), and a random-access memory (RAM). The CPU loads a program from the ROM or the memory 12 onto the RAM and then executes the program.

The memory 12 is a storage device, such as a flash memory or a hard disk drive (HDD). The memory 12 may be a storage device, such as a memory card, removable from the client terminal 1. The memory 12 stores a variety of files. The memory 12 may include a folder (or a directory) for synchronization set up to store a file shared between the client terminal 1 and the server 2.

Files may include a document file, an image file, an audio file, or a moving image file. Each file includes real data as content items of the file, and attribute data indicating an attribute of the real data associated with the real data. The real data is document data itself if the file is a document file, and image data itself if the file is an image file.

The memory 12 also stores an attribute table storing the attribute data of each file. More specifically, the memory 12 stores a basic attribute table 121 and a detailed attribute table 122.

FIG. 3 illustrates the data structure of the basic attribute table 121. The basic attribute table 121 stores a file name with basic attribute data thereof in association with each other concerning each file to be stored in a synchronization folder in the client terminal 1. Each record forming the basic attribute table 121 includes fields for a file name, storage location, size, and upload time and date.

The file name is identification information identifying the file. The storage location indicates a location where the real data of the file (hereinafter referred to as a “real file”) is stored in the client terminal 1. The size refers to the size of the real file. The upload time and date refers to time and date on which the real file is uploaded onto the server 2.

The real file may include thumbnail imager data of the file.

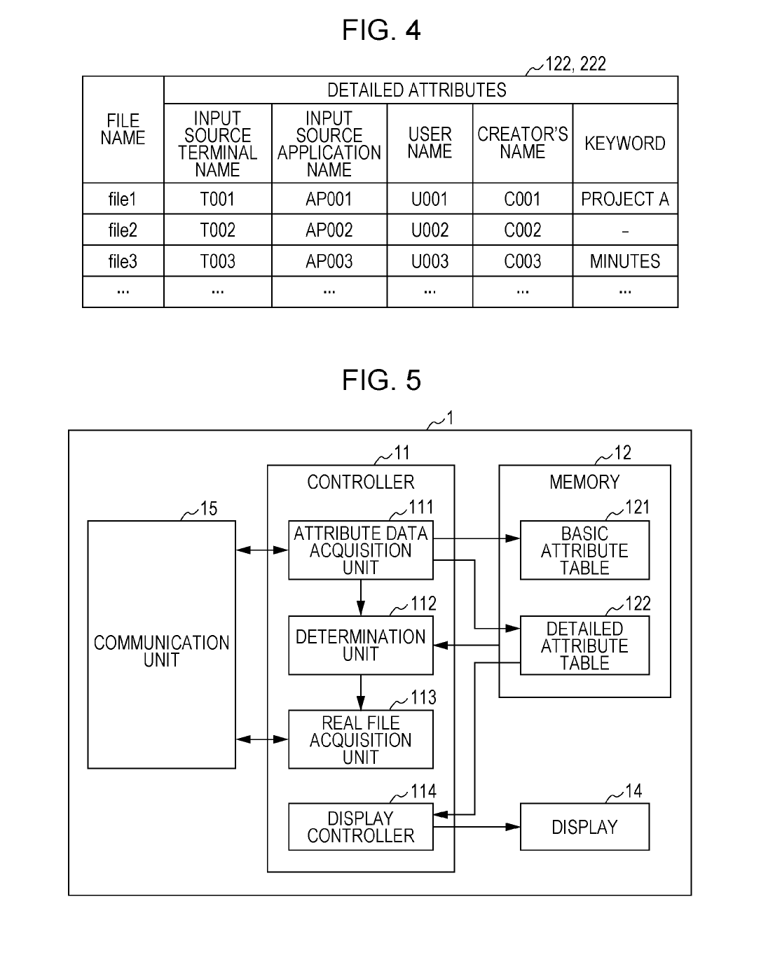

FIG. 4 illustrates an example of the data structure of the detailed attribute table 122. The detailed attribute table 122 stores a file name and detailed attribute data thereof in association with each other concerning each file to be stored in the synchronization folder of the client terminal 1. Each record forming the detailed attribute table 122 includes fields for a file name, input source terminal name, input source application name, user's name, creator's name, and keyword.

The file name is information identifying each file. The input source terminal name is information identifying the client terminal 1 having uploaded the file to the server 2. The input source application name is information identifying an application that has uploaded the file to the server 2. The user's name is information identifying the user of the client terminal 1 which has uploaded the file to the server 2. The creator's name is information identifying a creator who has created the file. The keyword is a condition according to which the file is searched for.

The memory 12 further stores information identifying a real file as a synchronization target. More specifically, the memory 12 stores attribute data indicating the attribute of the real file as the synchronization target. For example, the real file uploaded to the server 2 by a terminal A is a synchronization target, the memory 12 stores “input source terminal name: terminal A” as the attribute data (more specifically, a set of an attribute category and an attribute value). In another example, a real file having a file name “project A” may be set as a synchronization target, and then the memory 12 stores “file name: project A” as the attribute data.

In yet another example, a real file uploaded to the server 2 by a user A may be a synchronization target. The memory 12 then stores “user's name: user A” as the attribute data. In still another example, a real file uploaded to the server 2 within recent one week may be a synchronization target. The memory 12 then stores “upload time and date: within one week from present time” as the attribute data.

The attribute data to be stored on the memory 12 is preset by the user. Multiple pieces of the attribute data may be set up and stored on the memory 12. In such a case, pieces of the attribute data may be combined in accordance with an AND condition or an OR condition.

The operation unit 13 may be a device, such as a touch sensor, a keyboard, or a mouse. The operation unit 13 receives an operation that instructs a list of files stored in the synchronization folder to be displayed. The operation unit 13 also receives an operation that selects an icon image of a file displayed on the display 14.

The display 14 is a liquid-crystal display, for example. The display 14 may display an icon image of a file to be stored on the memory 12. The display 14 is an example of a notification unit in the exemplary embodiment. The display 14 may not necessarily be integrated with the client terminal 1 in a unitary body.

The communication unit 15 is a communication interface, such as a data communication card. The communication unit 15 performs data communications with an external apparatus via the communication network 3.

FIG. 5 is a functional block diagram of the controller 11. The controller 11 implements the functions of an attribute data acquisition unit 111, a determination unit 112, a real file acquisition unit 113, and a display controller 114 by executing a program stored on the ROM or the memory 12.

If a single real file as a content item has been added or updated on the server 2, the attribute data acquisition unit 111 acquires the attribute data indicating the attribute of that real file.

The determination unit 112 determines whether the attribute indicated by the attribute data acquired by the attribute data acquisition unit 111 and the attribute of the real file set to be an acquisition target in the client terminal 1 satisfy a predetermined condition. More specifically, the determination unit 112 determines whether the attribute indicated by the attribute data acquired by the attribute data acquisition unit 111 matches the attribute of the real file set as the acquisition target in the client terminal 1. In other words, the determination unit 112 determines whether the files satisfy the synchronization condition.

If the determination result by the determination unit 112 is affirmative, the real file acquisition unit 113 acquires the real file.

The display controller 114 controls the display 14 to notify the user of the attribute indicated by the attribute data acquired by the attribute data acquisition unit 111. The display controller 114 is an example of a “notification controller” in the exemplary embodiment.

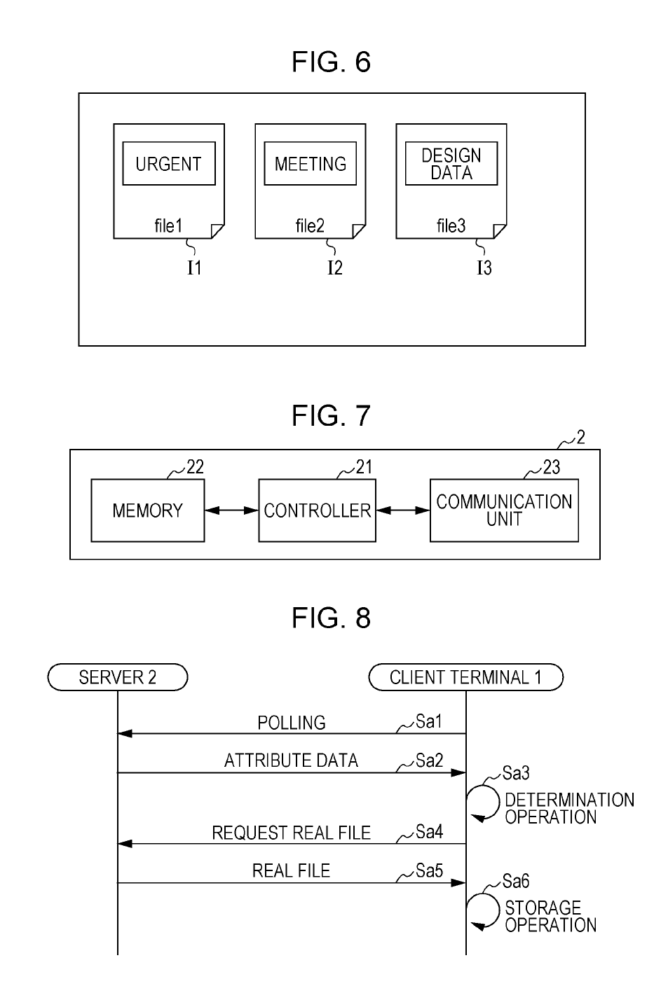

FIG. 6 illustrates an example of a screen displayed on the display 14. The screen displays a list of files stored in the synchronization folder. The screen is displayed in response to a display instruction from the user, for example.

Icon images I1 through I3 illustrated in FIG. 6 respectively correspond to different images. Each icon looks like an actual file rectangular shape with solid outline. The icon includes an attribute display rectangular region where the attribute data of a corresponding real file (such as a creator's name, a keyword, and the like) is displayed.

When the icon image is generated, the image of fonts is generated from text data indicating the detailed attribute of the attribute data and is thus used as the icon image. The generated icon image may be formed as an icon image representing a front cover of the real file (in other words, a thumbnail image). The generated image of the fonts may be set to be larger in size than a predetermined font size. In the icon image where the image of the fonts are combined, a region where the image of the fonts is displayed (more specifically, a location and size of the region) may be predetermined. If the image of the fonts fails to fit into the predetermined region, the extra portion may be deleted.

If a single icon image is selected by the user with the screen of FIG. 6 displayed, the content items of the real file corresponding to the selected icon image are displayed.

FIG. 7 is a block diagram illustrating the hardware configuration of the server 2. The server 2 is an example of a “data memory” or a “data transmitter” in the exemplary embodiment. As illustrated in FIG. 7, the server 2 includes a controller 21, a memory 22, and a communication unit 23.

The controller 21 includes a CPU, a ROM, and a RAM, for example. The CPU loads a program from the ROM or the memory 22 onto the RAM and then executes the program. The memory 22 is a storage device, such as an HDD. In another example, the memory 22 may be arranged external to the server 2 and may be connected to the server 2 via the communication network 3. The memory 22 stores a variety of files. A folder (or a directory) for synchronization to store a file shared with the client terminal 1 is set up in the memory 22.

The memory 22 stores an attribute table that stores the attribute data of each file. More specifically, the memory 22 stores a basic attribute table 221 and a detailed attribute table 222.

The basic attribute table 221 stores a file name and basic attribute data thereof in association with each other concerning each file to be stored in the synchronization folder. The detailed attribute table 222 stores a file name and detailed attribute data thereof in association with each other concerning each file to be stored in the synchronization folder. The basic attribute table 221 and the detailed attribute table 222 are respectively similar in data structure to the basic attribute table 121 and the detailed attribute table 122 to be stored on the memory 12 in the client terminal 1, and the discussion thereof is omitted herein.

Storage location data to be stored in the basic attribute table 221 is different from the storage location data in the basic attribute table 121 and indicates a location where a real file is stored on the server 2.

A process of the communication system 100 is described below. More specifically, a file synchronization process to synchronize files between the client terminal 1 and the server 2 is described below.

FIG. 8 is a sequence chart illustrating an example of the file synchronization process. The client terminal 1 performs the file synchronization process of FIG. 8 periodically.

In the file synchronization process, the attribute data acquisition unit 111 in the client terminal 1 polls the server 2 (step Sa1). More specifically, the attribute data acquisition unit 111 requests the server 2 to send the attribute data of each file stored in the synchronization folder of the server 2, namely, the attribute data of each file stored in the basic attribute table 221 and the detailed attribute table 222. When a reception unit 211 in the server 2 receives a polling signal from the client terminal 1, a transmission unit 212 in the server 2 transmits to the client terminal 1 the attribute data of each file stored in the basic attribute table 221 and the detailed attribute table 222 (excluding the storage location data) (step Sa2).

When the attribute data acquisition unit 111 in the client terminal 1 receives the attribute data from the server 2, the determination unit 112 in the client terminal 1 performs a determination operation to determine whether to synchronize real files indicated by the acquired attribute data (step Sa3).

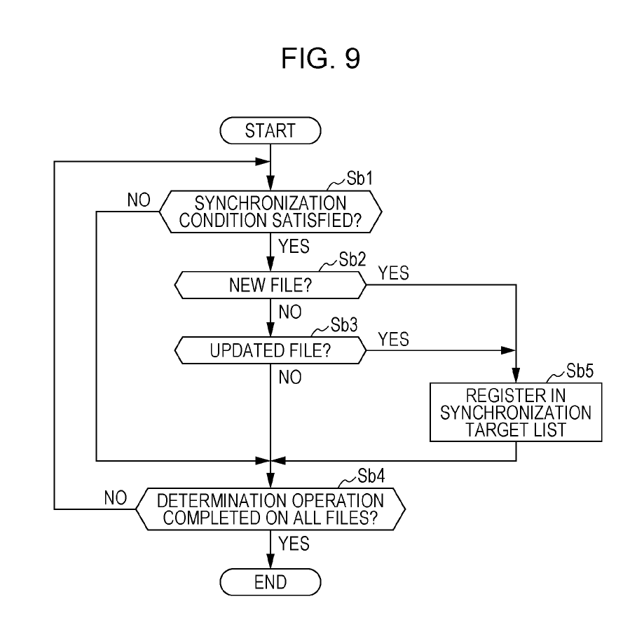

FIG. 9 is a flowchart illustrating an example of the determination operation.

In the determination operation, the determination unit 112 determines whether a file as a process target satisfies the synchronization condition (step Sb1). More specifically, the determination unit 112 determines whether the attribute indicated by the attribute data of the file as the process target matches the attribute of the real file predetermined as an acquisition target by the client terminal 1. If it is determined that the file as the process target fails to satisfy the synchronization condition (no branch from step Sb1), the determination unit 112 proceeds to step Sb4. The operation in step Sb4 is described below. If it is determined that the file as the process target satisfies the synchronization condition (yes branch from step Sb1), the determination unit 112 proceeds to step Sb2.

In step Sb2, the determination unit 112 determines whether the file as the process target is a file newly added to the server 2. More specifically, the determination unit 112 determines whether the file name of the file has been described in the basic attribute table 121. If the file name of the file has not been described in the basic attribute table 121 (no branch from step Sb2), in other words, if the file is a file newly added to the server 2, the determination unit 112 registers the file name of the file in a synchronization target list on the RAM (step Sb5). If the file name is registered in the basic attribute table 121 (no branch from step Sb2), in other words, if the file is not a file newly added to the server 2, the determination unit 112 proceeds to step Sb3.

In step Sb3, the determination unit 112 determines whether the file as the process target is a file updated in the server 2. More specifically, the determination unit 112 compares the data of upload time and date received from the server 2 with the data of upload time and date stored on the basic attribute table 121 to determine whether the two pieces of data are different or not. If the two pieces of data are different (yes branch from step Sb3), more specifically, if the file is a file updated on the server 2, the determination unit 112 registers the file name of the file in the synchronization target list (step Sb5). If the two pieces of document are not different (no branch from step Sb3), more specifically, if the file is not a file updated on the server 2, the determination unit 112 proceeds to step Sb4.

In step Sb4, the determination unit 112 determines whether the synchronization determination has been performed on all the files indicated by the attribute data acquired from the server 2. If the synchronization determination has been performed on all the files (yes branch from step Sb4), the determination unit 112 ends the process. If the synchronization determination has not been performed on all the files (no branch from step Sb4), the determination unit 112 returns to step Sb1 and then determines whether an unprocessed file satisfies the synchronization condition.

The determination operation has been described.

When the determination operation is complete, the real file acquisition unit 113 in the client terminal 1 requests the server 2 to send the real file of the file registered in the synchronization target list (step Sa4). If multiple file names are registered in the synchronization target list, the real file acquisition unit 113 requests the server 2 to send the real files of the files from the list in the order from the top of the list. When the reception unit 211 in the server 2 receives the request from the client terminal 1, the transmission unit 212 in the server 2 reads the real file responsive to the request from the memory 22 and then transmits the real file to the client terminal 1 (step Sa5).

Upon receiving the real file from the server 2, the real file acquisition unit 113 stores the real file on the memory 12 (step Sa6). If the acquired real file is a real file newly added to the server 2, the real file acquisition unit 113 newly stores the attribute data of the real file in the basic attribute table 121 and the detailed attribute table 122. If the acquired file is a real file updated on the server 2, the real file acquisition unit 113 overwrites the unupdated real file with the acquired real file, and thus updates the attribute data stored in the basic attribute table 121 and the detailed attribute table 122.

The file synchronization process has been described.

If a file is newly added or updated on the server 2 in the communication system 100 of the exemplary embodiment, the client terminal 1 determines whether the synchronization process is to be performed on the real file. If the determination result indicates that the synchronization process is to be performed, the synchronization process is performed on the real file with the server 2. The communication system 100 is thus free from modifying the settings on the server 2 when a real file to be synchronized in the client terminal 1 is specified.

Possible insufficiency of memory in the client terminal 1 in the communication system 100 is controlled more than the case in which the synchronization process is performed on all the real files added or updated on the server 2. Failure to perform the synchronization process caused by an excessive use of memory is controlled. Since communication traffic with the server 2 is reduced, resources for the communication process in the client terminal 1 are also reduced. In particular, if the client terminal 1 is a mobile terminal, the number of real files acquired is limited, and the user may easily access a desired file.

### Modifications

The exemplary embodiment may be modified as described below. Modifications described below may be used alone or in combination.

### Modification 1

The client terminal 1 in the exemplary embodiment displays an icon image of a file of a synchronized real file on the screen. The client terminal 1 may also display an icon image of a file of a real file that is not yet synchronized. The client terminal 1 may receive from the user an instruction to synchronize a real file through a selection operation of an icon image.

In a modification 1, not only the attribute data of a synchronized real file but also the attribute data of an unsynchronized real file may be stored in the basic attribute table 121 and the detailed attribute table 122.

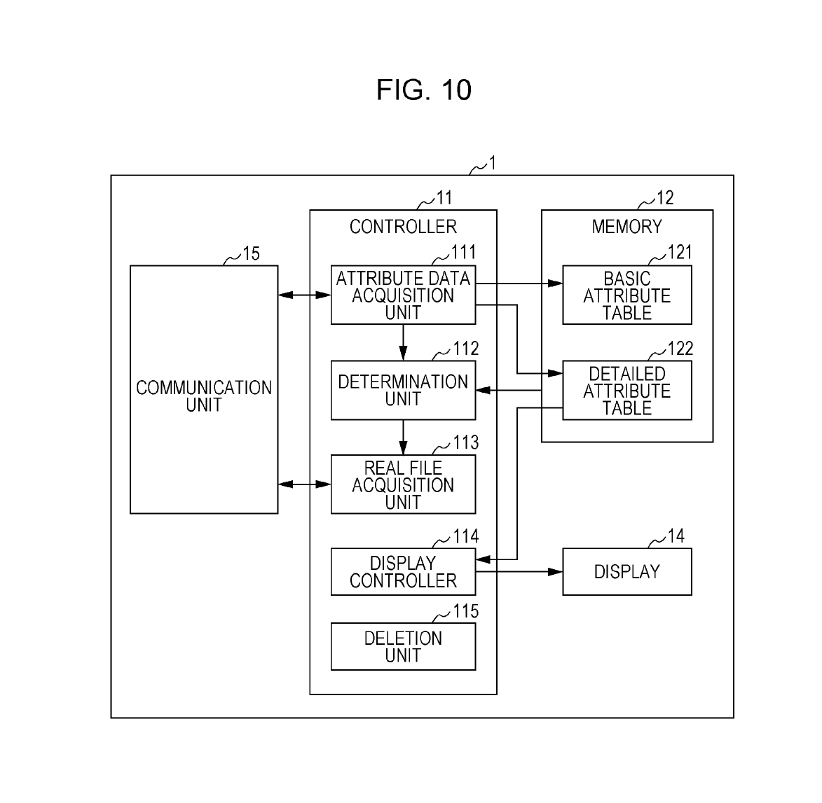

FIG. 10 is a functional block diagram of the controller 11 of the modification 1. In the modification 1, a deletion unit 115 is added.

In the modification 1, the real file acquisition unit 113 acquires the real file in response to an acquisition instruction of the real file from the user if the determination result of the determination unit 112 is non-affirmative.

When the real file acquisition unit 113 acquires the real file in response to the non-affirmative result by the determination unit 112, the display controller 114 controls the display 14 to notify the user of the content items of the acquired real file.

The deletion unit 115 deletes from the client terminal 1 the real file after the display controller 114 has notified of the content items of the real file. The operation of deletion includes not only fully deleting the real file from the memory 12 by overwriting, but also making a region having stored the real file open to be available as a new data storage region.

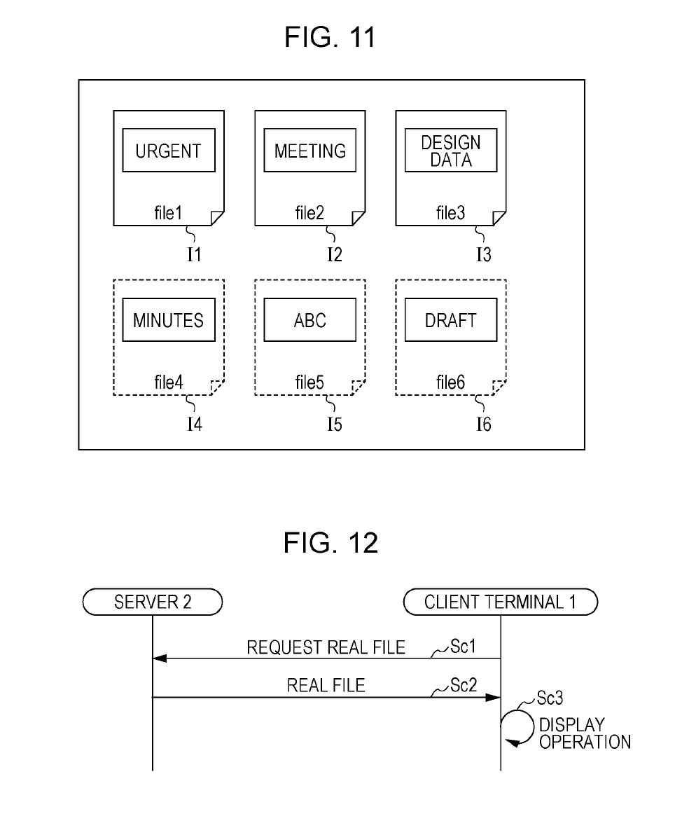

FIG. 11 illustrates an example of the screen displayed on the display 14 in the modification 1. The screen displays a list of files stored in the synchronization folder. The screen is displayed in response to a display instruction received from the user, for example.

Icon images I1 through I6 illustrated in FIG. 11 correspond to different files, and each icon looks like an actual file rectangular shape with solid outline. The icon includes an attribute display rectangular region where the attribute data (such as a creator's name, a keyword, and the like) of a corresponding real file is displayed.

From among the icon images I1 through I6, icon images I1 through I3 correspond to files of synchronized real files, and have solid outlines. Icon images I4 through I6 correspond to files of real files that have not been synchronized, and have broken outlines.

If the user selects one of the icon images I1 through I3 on the screen, the content items of the real file corresponding to the selected icon image are displayed. If the user selects one of the icon images I4 through I6 and instructs the real file to be synchronized, the real file synchronization process is performed as described below.

FIG. 12 is a sequence chart of an example of the real file synchronization process.

In step Sc1 of the real file synchronization process, the real file acquisition unit 113 in the client terminal 1 requests the server 2 to send the real file corresponding to the icon image selected by the user. When the reception unit 211 in the server 2 receives the request from the client terminal 1, the transmission unit 212 in the server 2 reads the real file from the memory 22 and then transmits the real file to the client terminal 1 (step Sc2).

When the real file acquisition unit 113 in the client terminal 1 receives the real file from the server 2, the display controller 114 in the client terminal 1 controls the display 14 to notify the user of the content items of the acquired file (step Sc3).

Upon receiving a display end instruction of the real file from the user later, the deletion unit 115 in the client terminal 1 deletes the real file from the client terminal 1.

In accordance with the modification 1, a real file is individually acquired and viewed even if the real file is included in the real files that are not synchronization targets.

### Modification 2

In the modification 1, the attribute data of a real file as a synchronization target may be set and stored on the memory 12 by selecting an icon image on the screen of FIG. 11. For example, the user may select the icon image 14 on the screen. The attribute data (a file name “file4”, for example) of the file corresponding to the icon image may be set and stored as information identifying the real file as the synchronization target on the memory 12.

### Modification 3

In the file synchronization process of the exemplary embodiment, the real file acquisition unit 113 may acquire the real files in accordance with the priority order thereof when the real files of the files registered in the synchronization target list are acquired. In a modification 3, the user may view a real file more quickly as the real file is higher in the priority order. Also, as a real file is higher in the priority order, a failure in the synchronization process caused by an excess use of memory is controlled more.

The prior order of the synchronization process may be set on a per file basis. In the exemplary embodiment, for example, the files may be prioritized by allowing the user to select the icon images I1 through I3 in the priority order on the screen of FIG. 6.

The priority order of the synchronization process is may be set on a per attribute basis of each real file. In such a case, each file is indirectly prioritized using the attribute data.

If a file not prioritized is registered in the synchronization target list, the synchronization of that file may be performed later than a prioritized file. Conversely, a file not prioritized may be synchronized prior to the synchronization of a prioritized file.

### Modification 4

The program executed by the controller 11 in the client terminal 1 or the controller 21 in the server 2 in the exemplary embodiment and the modifications may be supplied in a recorded state on one of a storage media including a magnetic tape, a magnetic disk, a flexible disk, an optical disk, a magneto-optical disk, and a memory. The program may also be downloaded via a communication network, such as the Internet.

### Other Modifications

In the file synchronization process of the exemplary embodiment, the client terminal 1 polls the server 2. Alternatively, upon detecting an addition or update of a file, the server 2 may notify the client terminal 1 of the addition or update. The file synchronization process may be performed in response to an instruction from the user.

In the exemplary embodiment, the synchronization of the real file of each file is performed from the server 2 to the client terminal 1 in a simplex fashion. Alternatively, the synchronization of the real file may be performed in a duplex fashion.

The icon images are described for exemplary purposes only in the exemplary embodiment and the modifications. A different icon image may also be used as long as the icon notifies the user of the presence of a file and the attribute of the file. In the exemplary embodiment, the icon image may not necessarily have to include an attribute display region. In the modification 1, whether the real file is synchronized or not may be indicated by any form other form than the type of the outline of each icon. A form to notify the user of the presence of a file is not limited to an icon (pictorical symbol). Characters or symbols may also be used.

In the exemplary embodiment, the attribute indicated by the attribute data acquired by the attribute data acquisition unit 111 and the content items of the real file acquired by the real file acquisition unit 113 may be notified to the user by using a speaker or by controlling a vibration device. The speaker or the vibration device is an example of a “notification unit” in the exemplary embodiment.

In the exemplary embodiment, the basic attribute data of the file may include time and date of creation, and time and date of update. The time and date of creation refers to time and date on which a real file is created, and the time and date of update refers to latest time and date on which a real file is updated. The detailed attribute data of the file may include a title and comment. The title refers to a title or a summary of contents represented by the real file, and the comment refers to an explanation related to the contents represented by the real file.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication terminal comprising:
an attribute data acquisition unit that acquires attribute data indicating an attribute of real data if at least a single piece of the real data is added or updated as one of content items on a data memory;
a notification controller that controls a notification unit to notify a user of the attribute indicated by the attribute data acquired by the attribute data acquisition unit; and
a real data acquisition unit that acquires real data predetermined as an acquisition target by the communication terminal with the notification controller not notifying the user of the attribute indicated by the attribute data if the attribute indicated by the attribute data acquired by the attribute data acquisition unit matches the attribute of the predetermined real data.

2. The communication terminal according to claim 1, wherein the real data acquisition unit acquires the real data in response to an acquisition instruction for the real data made by the user if the attribute indicated by the attribute data acquired by the attribute data acquisition unit fails to match the attribute of the real data predetermined as the acquisition target in the communication terminal, or if the attribute of the real data is not predetermined as the acquisition target in the communication terminal.

3. The communication terminal according to claim 2, wherein the notification controller controls the notification unit to notify the user of a content item indicated by the acquired real data with the real data acquisition unit having acquired the real data if the attribute indicated by the attribute data acquired by the attribute data acquisition unit fails to match the attribute of the real data predetermined as the acquisition target in the communication terminal, or if the attribute of the real data is not predetermined as the acquisition target in the communication terminal, and
wherein the communication terminal further comprises a deletion unit that deletes the real data from the communication terminal after the notification controller has notified the user of the content item of the real data.

4. The communication terminal according to claim 1, wherein if the attribute data acquisition unit has acquired the attribute data of a plurality of pieces of the real data, the attribute indicated by the attribute data acquired by the attribute data acquisition unit matches the attribute of the real data predetermined as the acquisition target in the communication terminal, and the pieces of the real data are set in a priority order, the real data acquisition unit acquires the pieces of the real data in the priority order.

5. The communication terminal according to claim 2, wherein if the attribute data acquisition unit has acquired the attribute data of a plurality of pieces of the real data, the attribute indicated by the attribute data acquired by the attribute data acquisition unit matches the attribute of the real data predetermined as the acquisition target in the communication terminal, and the pieces of the real data are set in a priority order, the real data acquisition unit acquires the pieces of the real data in the priority order.

6. The communication terminal according to claim 3, wherein if the attribute data acquisition unit has acquired the attribute data of a plurality of pieces of the real data, the attribute indicated by the attribute data acquired by the attribute data acquisition unit matches the attribute of the real data predetermined as the acquisition target in the communication terminal, and the pieces of the real data are set in a priority order, the real data acquisition unit acquires the pieces of the real data in the priority order.

7. A communication system comprising:
the communication terminal according to claim 1; and
a data transmitter that transmits, to the communication terminal, real data as a content item.

8. A communication method comprising:
acquiring attribute data indicating an attribute of real data if at least a single piece of the real data is added or updated as one of content items on a data memory;
controlling a notification unit to notify a user of the attribute indicated by the acquired attribute data; and
acquiring real data predetermined as an acquisition target without notifying the user of the attribute indicated by the attribute data if the attribute indicated by the acquired attribute data matches the attribute of the predetermined real data.

9. A non-transitory computer readable medium storing a program causing a computer to execute a process for communication, the process comprising:
acquiring attribute data indicating an attribute of real data if at least a single piece of the real data is added or updated as one of content items on a data memory;
controlling a notification unit to notify a user of the attribute indicated by the acquired attribute data; and
acquiring real data predetermined as an acquisition target without notifying the user of the attribute indicated by the attribute data if the attribute indicated by the acquired attribute data matches the attribute of the predetermined real data.
